(19) United States
(12) Patent Application Publication
(10) Pub. No.: US 2010/0025406 A1
(43) Pub. Date: Feb. 4, 2010

(54) Vertical Storage Vessel

(76) Inventor: Greg E. McRae, Irving, TX (US)

Correspondence Address: BAKER BOTTS L.L.P., 2001 ROSS AVENUE, SUITE 600, DALLAS, TX, 75201-2980, US

(21) Appl. No.: 11/763,232

(22) Filed: Jun. 14, 2007

Related U.S. Application Data
(60) Provisional application No. 60/911,791, filed on Apr. 13, 2007.

(51) Int. Cl. F17C 1/00; F17C 13/00

(52) U.S. Cl. 220/560.04; 62/45.1

(57) ABSTRACT

A vessel for containing liquefied petroleum gas and a method for loading a semitrailer with a plurality of vessels is disclosed. The vessel may include a tank with an outside diameter that is greater than thirty inches and less than thirty-four inches. The tank may be configured to contain at least 119 water gallons, and may be further configured to contain liquefied petroleum gas.

### RELATED APPLICATIONS

This application claims the benefit of U.S. Provisional Application Ser. No. 60/911,791, filed Apr. 13, 2007, entitled Vertical Storage Vessel, which is hereby incorporated by reference.

### TECHNICAL FIELD OF THE INVENTION

The present disclosure is related to storage vessels and more particularly, to vertical storage vessel systems and methods for example, for storing liquefied petroleum gas (“LPG”).

### BACKGROUND OF THE INVENTION

Storage vessels or tanks are used to store volatile liquids and gases. For example, LPG tanks are often used to contain liquefied petroleum gas such as propane. LPG tanks come in a variety of sizes and are used in both commercial and residential applications. LPG tanks are often used in residential applications to provide fuel for fireplaces, stoves, and dryers. LPG tanks may be used in commercial application to provide fuel to heat a building.

To get an LPG tank from the manufacturer to a retailer or other user that may fill the tank and offer it for sale, multiple LPG tanks may be transported on a semitrailer(s) having certain dimensions governed by federal regulations.

### SUMMARY OF THE INVENTION

The teachings of the present invention include a storage vessel that has dimensions selected to increase the number of vessels that can be transported on a semitrailer. In accordance with a particular embodiment of the present invention, a vessel for containing liquefied petroleum gas includes a tank. The tank may have an outside diameter that is greater than thirty inches and less than thirty-four inches. The tank may be configured to contain at least 119 water gallons, and may be further configured to contain liquefied petroleum gas.

In accordance with another embodiment of the present invention, a method for loading a semitrailer with vessels includes providing a plurality of vessels. Each vessel may have an outside diameter that is greater than thirty inches and less than thirty-four inches. Each vessel may be configured to contain at least 119 water gallons, and may be further configured to contain liquefied petroleum gas. At least thirteen stacks of vessels may be loaded on a semitrailer, wherein each stack comprises nine vessels, and wherein an imaginary centerline of each vessel is substantially horizontal.

Technical advantages of particular embodiments of the present invention include an LPG tank that has the capacity to hold 119 water gallons and is sized to increase the number of tanks that may be loaded on a semitrailer for transport.

Further technical advantages of particular embodiments of the present invention include a tank that is relatively shorter and has a greater outer diameter than a conventional LPG tank, that is still capable of being used in conventional tank applications.

Still further technical advantages of the present invention include an LPG tank that is less than four feet tall, which is the standard height for the sill of a window in a residence. Therefore, an LPG tank in accordance with the teachings of the present invention may be placed on the outside of a residence near a window and not block a view out of the window.

Still further technical advantages of the present invention include valve and fitting placement that may make fluid communication among multiple LPG tanks easier. Allowing fluid communication among LPG tanks may substantially increase the quantity of available propane for certain applications. Still further technical advantages of the present invention include an improved design of an LPG tank collar and lid interface that may improve manufacturing and assembly.

Other technical advantages will be readily apparent to one of ordinary skill in the art from the following figures, descriptions and claims. Moreover, while specific advantages have been enumerated above, various embodiments may include all, some, or none of the enumerated advantages.

### BRIEF DESCRIPTION OF THE DRAWINGS

A more complete understanding of the present embodiments and advantages thereof may be acquired by referring to the following description, taken in conjunction with accompanying drawings, in which like reference numbers indicate like features, and wherein:

FIG. 1 is a schematic drawing of an embodiment of the present invention having an illustration of a conventional LPG tank superimposed;

FIG. 2A is a schematic drawing of a side view of an LPG vessel in accordance with an embodiment of the present invention;

FIG. 2B is a schematic drawing of a top view of an LPG vessel in accordance with an embodiment of the present invention;

FIG. 2C is a schematic drawing showing the detail of a head to shell seam in accordance with an embodiment of the present invention;

FIG. 2D is a schematic drawing of an embodiment of the present invention showing a lid and collar interface in partially exploded view;

FIG. 3 is an illustration of an embodiment of the present invention showing a load layout of a semitrailer loaded with LPG vessels in accordance with an embodiment of the present invention;

FIG. 4 is a schematic drawing of another embodiment of the present invention showing a second load layout of a semitrailer loaded with LPG vessels in accordance with an embodiment of the present invention;

FIG. 5 is a schematic drawing of an embodiment of the present invention showing an end view of a semitrailer loaded with LPG vessels in accordance with an embodiment of the present invention;

FIG. 6 is a schematic drawing illustrating a detailed view of an embodiment of the present invention showing LPG vessels separated by protective material; and

FIG. 7 is an illustration of a load layout of a semitrailer loaded with 320 gallon LPG vessels in accordance with a further embodiment of the present invention.

### DETAILED DESCRIPTION OF THE INVENTION

The present disclosure is directed to a liquefied petroleum gas (“LPG”) tank assembly which may also be referred to as a vessel. Dimensions of the tank assembly may be selected to allow the tank to hold a certain quantity of liquid or pressurized gas while still allowing a maximum number of tanks to be transported on a semitrailer having length and width dimensions in compliance with United States federal size regulations for commercial vehicles.

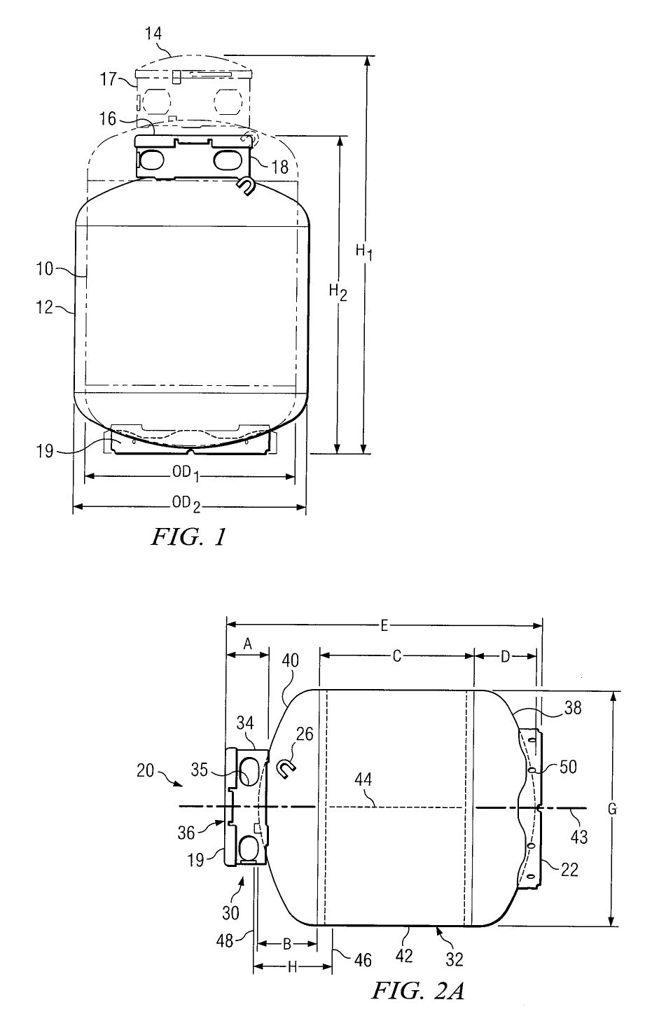

FIG. 1 illustrates an improved LPG tank assembly 12 which may also be described as a vertical storage vessel, a bottle, or a cylinder. Improved LPG tank assembly 12 is shown in FIG. 1 by solid lines. Superimposed over improved LPG tank 12 is conventional LPG tank 10, illustrated by broken lines on the drawing. Both improved LPG tank 12 and conventional LPG tank 10 are capable of holding 119 water gallons. Improved LPG tank 12 is shorter and wider than conventional LPG tank 10. The outer diameter of conventional LPG tank 10 (OD₁) may be 30 inches while the outer diameter of improved LPG tank 12 (OD₂) may be 33 inches. In accordance with particular embodiments of the present invention, OD₂ may be greater than 30 inches and less than or equal to 35 inches. OD₂ may also be greater than 31 inches and less than 34 inches.

Conventional LPG tank 10 includes a domed lid 14 and a standard collar 17. Improved LPG tank 12 also achieves reduced height for example, by replacing domed lid 14 with flat lid 16 and replacing standard collar 17 with shorter, improved collar 18.

By reducing the height of the collar, flattening the lid, and increasing the outer diameter, improved LPG tank 12 may have an overall height (H₂). H₂ may be greater than or equal to 44 inches and less than or equal to 55 inches. In accordance with other embodiments of the present invention, H₂ may be greater than or equal to 44 inches and less than or equal to 48 inches. In accordance with particular embodiments of the present invention, H₂ may be equal to 44.085 inches. A reduced height base 19 may also contribute to reduced height H₂. Improved LPG tank 12 achieves a significant reduction in height from height H₁ of conventional LPG tank 10 which may be 55.375 inches to H₂, which may be 44.085 inches, the difference being H₁−H₂ or 11.290 inches.

Consistent with the teachings of the present invention, LPG vessels of various capacities may have reduced length and increased outer diameter compared to conventional tanks of the same capacity or volume. For example, LPG vessels that are capable of containing 320 water gallons may be made to have a reduced length of 84 and 3/16ths inches and an outer diameter of 33 inches. 400 water gallon LPG vessels may also have a 33 inch outer diameter consistent with the teachings of the present invention.

A 119 water gallon LPG vessel in accordance with the teaching of the present invention may have a volume or capacity in water gallons that is greater than or equal to 3.4 and less than or equal to 3.9 times its outer diameter in inches. It may also have a volume in gallons that is less than or equal to 3.8 and greater than or equal to 3.5 times its outer diameter in inches. In accordance with a particular embodiment of the present invention, a 119 water gallon LPG vessel may have a volume or capacity (119 gallons) that is 3.6 times the outer diameter of the vessel in inches. In addition, the volume or capacity in water gallons (119 water gallons) of an LPG vessel in accordance with the teachings of the present invention may be 2.7 times its height in inches.

In accordance with a particular embodiment of the present invention, a 320 water gallon LPG vessel may have a volume or capacity in water gallons that is 3.8 times its length in inches.

In accordance with particular embodiments of the present invention, an LPG vessel may have a height in inches that is greater than or equal to 1.33 and less than or equal to 1.67 times its outer diameter in inches. A particular embodiment of the present invention may have a height in inches that is equal to 1.45 times its outer diameter in inches.

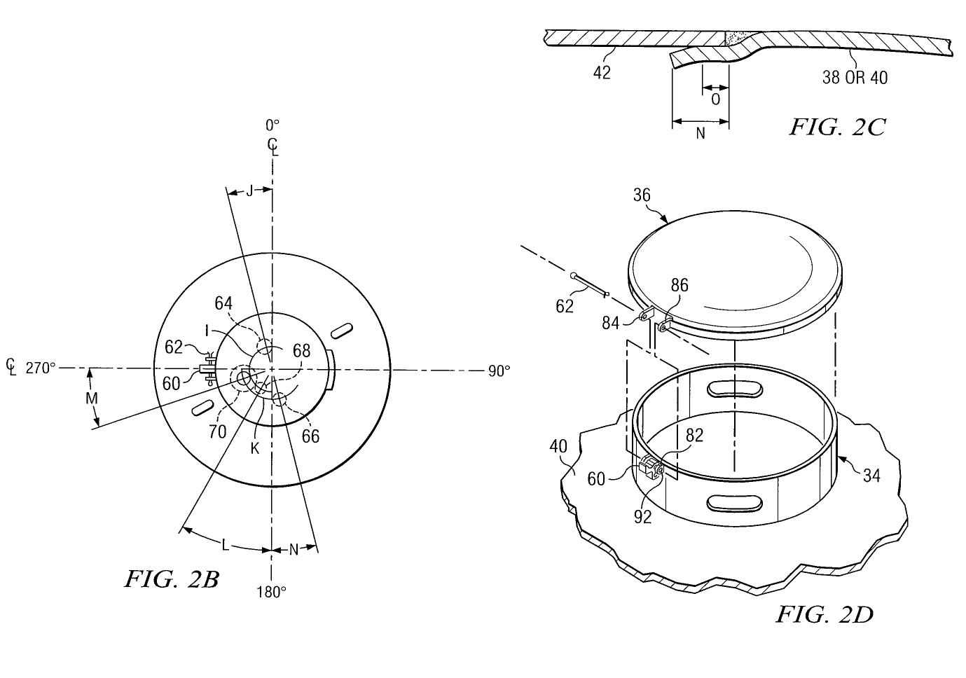

FIG. 2A illustrates an LPG tank assembly or vessel 20 in accordance with a particular embodiment of the present invention. Tank assembly 20 includes base 22, tank 32, lifting lug 26, and cover assembly 30. A cylindrical collar 34 is fixed to the top of tank 32 and includes two visible access openings 35. Cylindrical collar 34 may surround valves and fittings located at the top of tank 32. The valves and fittings allow access to the contents of tank 32 and further allow tank 32 to be filled.

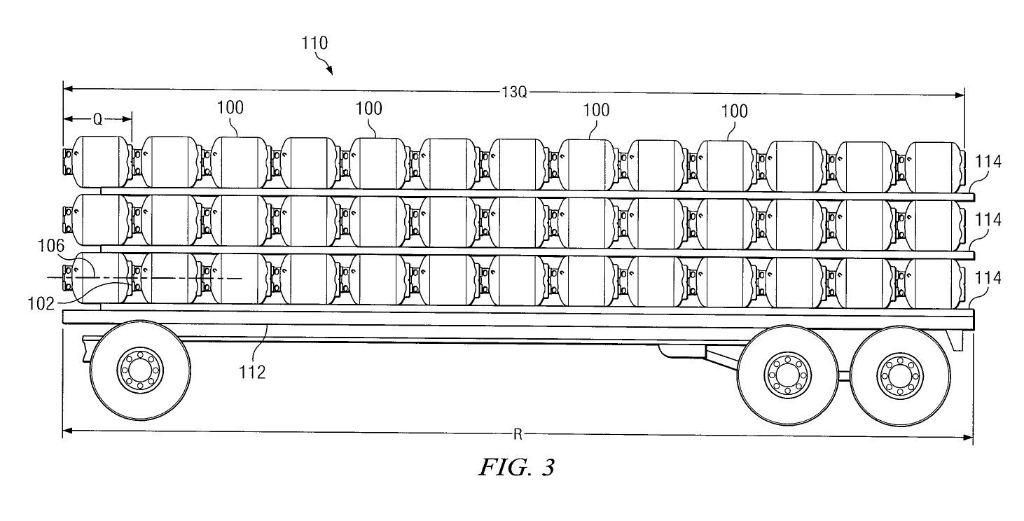

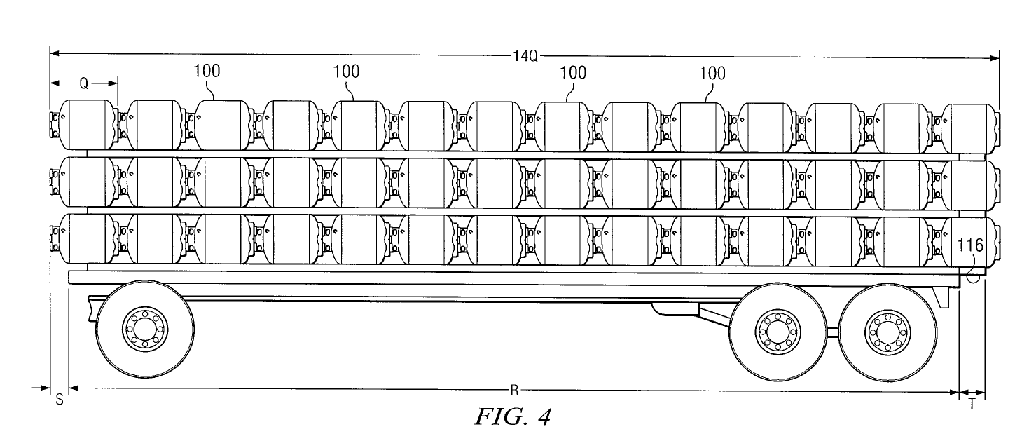

Lid 36 includes top surface 19 that is flat and generally perpendicular to an imaginary centerline 43 of tank 32 when lid 36 is in its closed position. Being flat, top surface 19 of lid 36 decreases the overall height E of LPG tank assembly or vessel 20. By decreasing the overall height of LPG tank assembly 20, more tank assemblies 20 may fit on a semitrailer as shown in FIGS. 3 and 4. The height of cylindrical collar 32 may be selected to allow cylindrical collar 32 to adequately protect the valves and fittings and also to minimize the overall height of LPG tank assembly 20.

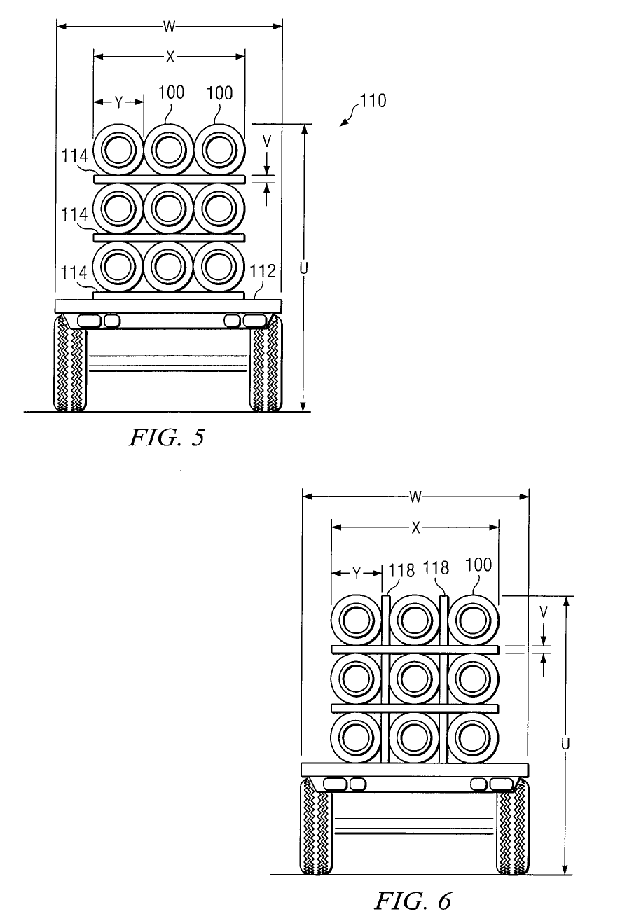

The outer diameter of tank 32 and LPG tank assembly 20 is designated in FIG. 2A as G. LPG tank assembly 20 may be a 119 gallon LPG tank. Outer diameter G may be selected such that LPG tank assembly 20 is capable of holding 119 water gallons and also selected to allow three tanks on their side and positioned generally tangent to each other on a semitrailer to maximize the surface of the semitrailer occupied by the vessels (see FIG. 5). In certain embodiments of the present invention, outer diameter G may be equal to 33 inches and overall height E may be equal to 44.085 inches Tank 32 includes shell ring 42, bottom head 38 and top head 40. Shell ring 42 may be 0.192 inches thick and 22 inches long (dimension C). It may also have longitudinal seam 44 created by welding two lateral edges of shell ring 42 together with a full weld. Shell ring 42 may be fixed to top head 40 and bottom head 38 with a spot weld performed in accordance with UW-11(a) (5) (b). See FIG. 2C.

Bottom head 38 and top head 40 may each be a 2:1 elliptical head with a 0.172 inch minimum thickness in accordance with ASME standards. Bottom head 38 and top head 40 may also have thicknesses in accordance with U.S. Department of Transportation standards. Bottom head 38 and top head 40 may have an outer diameter of 33 inches. Top head 40 may be substantially similar to bottom head 38 with the exception that top head 40 may have prepunched holes to receive couplings that will fit valves and other fittings of tank assembly 20. Top head 40 and bottom head 38 may have respective heights B and D of 8.340 inches.

LPG tank assembly 20 may be composed of material in accordance with ASME standards or may be material specified by U.S. Department of Transportation regulations for portable cylinders. In accordance with ASME standards governing pressure vessels, top head 40 and bottom head 38 may be made of SA414G steel. Shell ring 42 may be made of SA455 steel. A36 steel or equivalent may be the material for collar 34, base 22, and lift lug 26. The couplings welded to top head 40 may be SA105 steel. Collar 34 may have 3 tabs to facilitate welding to top head 40. Lid 36 may have a 16 inch outer diameter and may be made of C.Q. G-30 galvanized carbon steel.

Reference number 46 indicates a reference line at the level of tank assembly 20 to which liquid would rise when the tank is 80% full. Dimension H shows 80% liquid level 46 being 10.1 inches below the top of coupling 48. Cover assembly 30 may have an overall height of A, where A equals 5.8125 inches. Base hole 50 may be aligned with lift lug 26.

FIG. 2B illustrates a top view of tank assembly 20. The location of the valve couplings are visible from FIG. 2B. Valve couplings are located on arcs I and K. Arc I may have a radius of 3.250 inches, and arc K may have a radius of 4.298 inches. Valve coupling 64 and valve coupling 68 are located on arc I. Valve couplings 66 and 70 are located on arc K. This configuration allows valve couplings 70, 68, and 66 to be substantially in a straight line.

Valve couplings 64, 66, 68, and 70 may be a 3000# half coupling and may be three quarters of an inch, one inch, or one and one quarter inches in diameter. Valve coupling 64 may be capable of receiving a fill valve. Valve coupling may be capable of receiving a relief valve, and valve coupling 68 may be capable of receiving a service valve. Coupling 70 may be capable of receiving a float gauge.

The specific location of valve couplings 64, 66, 68, and 70 may allow a T-block to be coupled to a service valve secured to valve coupling 68. This T-block may allow multiple LPG tank assemblies to be coupled to each other through a conduit that is received by the T-block through collar 34 at a access opening 35. This may allow multiple tank assemblies to be coupled together while lid 36 remains in a closed position. By coupling multiple tanks, available propane is increased to 240 gallon capacity or more without having to install a larger capacity tank.

Lid stop 60 may be coupled to cover assembly 30 by cotter pin 62. Cotter pin 62 may be 4 inches long. See FIG. 2D for more detail. Valve couplings 64, 66, 68, and 70 may be located at angles designated by J, L, M, and N, where J equals 15 degrees, L equals 30 degrees, M equals 19 degrees, and N equals 11 degrees.

FIG. 2C illustrates a detail of the seam where top or bottom head 38 or 40 may be welded to shell 42. Dimension N equals approximately 13/16 inches, and dimension O equals a minimum flat portion of 1 and ½ times the thickness of the steel. The seam shown may be created by in accordance with ASME standards by a spot x-ray per UW-11 (a) (5) (b) with a weld re-enforcement inside and outside of ⅛th of an inch. The seam may also be created in compliance with U.S. Department of Transportation regulations governing portable cylinders.

FIG. 2D illustrates an isometric view of the coupling between lid 36 and collar 34. Two collar tabs 82 each may have an aperture to receive cotter pin 62. Two corresponding lid tabs 86 each may also include an aperture 84 to receive cotter pin 62.

Collar tabs 82 may be formed by a multi-stage die as opposed to being welded to collar 34. A first stage of a multi-stage die may form the basic features of collar 34. A second stage may form collar tabs 82 by removing material to create tab apertures 92 and the shape of collar tabs 82. A third stage of a multi-stage die may bend collar tabs 82 approximately 90 degrees such that they are in the position shown by FIG. 2D.

Similar to the formation of collar tabs 82, lid tabs 86 may also be formed by a multi-stage die. A first stage of a multi-stage dye may form the basic shape of lid 36. A second stage may remove material to form the shape of lid tabs 86 and apertures 84. A third stage may bend lid tabs 86 approximately 90 degrees to the position shown in FIG. 2D.

Collar tabs 82 may be spaced 3 inches apart and lid tabs 86 may be spaced 3.17 inches apart. Coupling lid 36 to collar 34 may be accomplished by aligning collar apertures 92 with lid apertures 84 and inserting cotter pin 90 through the four apertures. In accordance with a particular embodiment of the present invention, lid stop 60 may be formed and function in accordance with the teachings of U.S. patent application Ser. No. 11/563,992, which is hereby incorporated by reference as if fully set forth herein, and be inserted between collar tabs 82. Cotter pin 62 may couple lid 36, lid stop 60, and collar 34.

Tank assembly 20 may conform to the ASME code for pressure vessels, Section VIII, Division I or U.S. Department of Transportation regulations governing portable cylinders, NFPA 58. In compliance with ASME standards, the maximum allowable working pressure may be 250 PSIG at 125 degrees Fahrenheit. The minimum design metal temperature (“MDMT”) may be −20 degrees Fahrenheit at 250 PSIG. The hydrostatic test pressure of tank assembly 20 and the maximum allowable stress of top head 40, bottom head 38, and shell ring 42 may be in compliance with ASME or DOT standards. The weight of tank assembly 20 including the valve fittings may be approximately 320 pounds. The outside surface area may be 35 square feet, and the relief capacity required for LPG may be 990 standard cubic feet per minute.

FIGS. 3 and 5 illustrate an embodiment of the present invention. FIG. 3 is a side view of semitrailer 110 loaded with tank assemblies or vessels in accordance with an embodiment of the present invention. The tank assemblies or vessels may be 119 water gallon vessels. FIG. 5 is an end view of loaded semitrailer 110.

As shown in FIG. 3, loaded semitrailer 110 includes trailer bed 112. Trailer bed 112 may have a length R and a width W. Length R may be 48 feet and width W may be 102 inches. Length T and width W may be required to comply with federal size regulations for commercial motor vehicles, and thus may have particular length and width requirements. Multiple LPG tank assemblies 100 are shown on trailer bed 112. In accordance with a particular embodiment of the present invention, LPG tank assembly 100 may have height Q and outer diameter Y (see FIG. 5) that allow a maximum number of LPG tank assemblies 100 to be loaded and transported on trailer bed 112.

LPG tank assemblies 100 may be positioned on trailer bed 112 in groups of nine. As shown in FIG. 5, three LPG tanks 20 may be positioned substantially tangent to each other while laying on their sides. Three tank assemblies 100 may rest on shipping timbers 114. When tanks 100 are positioned substantially tangent to each other, they may occupy an overall tank width X. X may equal 8 feet 3 inches (99 inches) . Shipping timbers 114 may be 1 and 11/16ths inches thick. The overall height of loaded semitrailer 110 from the level of the ground to the top of the tank stacks is shown as dimension U. Height U may be selected to be less than certain state regulations governing the maximum height of a load carried by commercial motor vehicles. This maximum height may be 13 feet 6 inches. Dimension U may equal 12 foot 8 and ⅝ths inches.

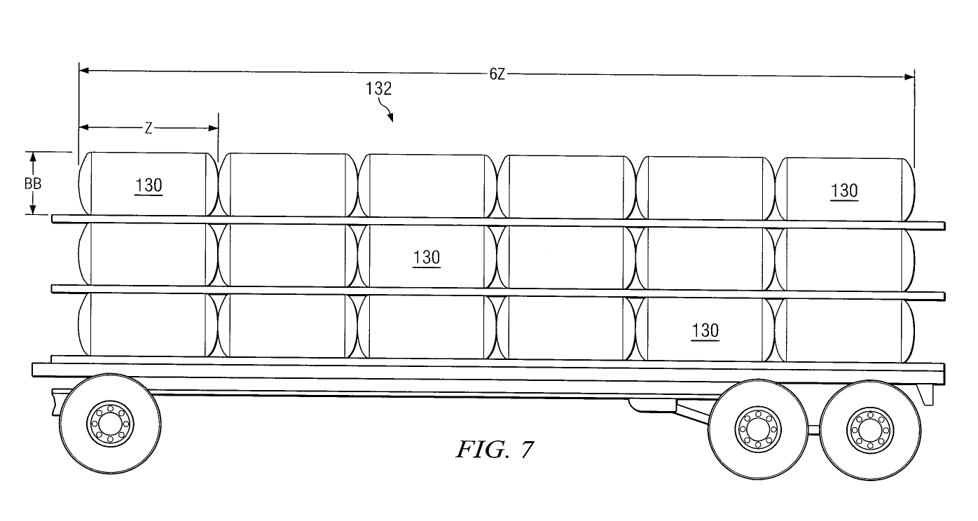

In accordance with a particular embodiment of the present invention, between each tank 100 may be material to protect each tank from contacting another tank and thereby damaging it. Protective material 118, shown in FIG. 6, may be padding, web strapping, or compressed foam. Protective material 118 may be selected and/or positioned so as to not significantly increase overall tank width X over 99 inches. Overall tank width X may be equal to or greater than 99 inches and less than or equal to 102 inches.

Shipping timbers 114 may be placed on top of three tank assemblies 100 to allow three more tank assemblies 100 to be stacked on top thereof. A stack of tank assemblies 100 may comprise nine tank assemblies created by stacking three sets of three tank assemblies on top of each other. The outer diameter of tank assembly 100, Y, may be selected such that it is less than trailer width W divided by three.

Each stack of nine tank assemblies 100 may be loaded onto trailer bed 112 for transport. The overall height Q of tank assembly 100 may be selected such that it is less than trailer length R divided by thirteen. Q may be 44.085 inches. This may allow thirteen stacks of nine tank assemblies 100 (117 tank assemblies) to be loaded and safely transported on trailer bed 112. The overall length of thirteen stacks of nine tank assemblies, 13Q, may be 47.76 feet. (44.085 inches×13). Each stack of nine tank assemblies 100 may be positioned on trailer bed 112 such that each tank assembly's imaginary center axis 106 is generally parallel to trailer bed 112. Each stack of nine tank assemblies 100 may be positioned such that base 102 of a tank assembly of a first stack is directly adjacent and nearly contacts a lid of a tank assembly 100 in an adjacent stack.

Another embodiment of the present invention is illustrated in FIG. 4. Trailer bed 112 may be capable of transporting fourteen stacks of nine tank assemblies 100 with the aid of an extension to trailer bed 112. The extension 116 to trailer bed 112 may be approximately 1 foot 3 and 13/16ths inches long. In addition to extension 116, a stack of nine tanks may extend approximately 1 foot 2 inches beyond the length of the trailer bed 112. This extension is shown by dimension S.

In accordance with a particular embodiment of the present invention, 126 tanks may be transported with one trailer load. The overall length of the fourteen stacks of tank assemblies may be 14Q. 14Q may equal 51 feet and 3 and ¾ths inches.

FIG. 7 illustrates a further embodiment of the present invention. FIG. 7 shows stacks of 320 gallon tank assemblies or vessels 130 loaded on semitrailer 132. Each 320 gallon tank 130 may have an overall length dimension Z of 84 and 3/16ths inches, and an overall radius BB of 33 inches. The overall length of six stacks of nine 320 gallon tanks may be shown by dimension 6Z. 6Z may be less than semitrailer length R, which is 48 feet. 6Z may be equal to 42.094 feet. FIG. 7 illustrates a side view of a 320 gallon tank load that is similar to FIG. 3 illustration of a 119 gallon tank load. Thus, each stack showing three tanks 130 on top of each other from a side view represents nine tanks positioned similar to the configuration shown in FIG. 5.

Accordingly, FIG. 7 depicts fifty-four 320 gallon vessels as they might be loaded on semitrailer 122. Conventionally sized 320 gallon tanks would require that less than fifty-four be transported on a 48 foot semitrailer that complies with federal size regulations for commercial motor vehicles. Conventional 320 gallon tanks may be transported in loads of 45 tanks. The teachings of the present invention may also be used for a 400 gallon tank assembly with a 33 inch outer diameter and a reduced length.

Although the present invention has been described in several embodiments, a myriad of changes and modifications may be suggested to one skilled in the art, and it is intended that the present invention encompass such changes and modifications as fall within the scope of the present appended claims.

What is claimed is:

1. A vessel for containing liquefied petroleum gas, comprising:
a tank having an outside diameter that is greater than thirty inches and less than thirty-four inches, the tank being configured to contain at least 119 water gallons, and being further configured to store liquefied petroleum gas.

2. The vessel of claim 1, wherein the tank has an outside diameter of thirty-three inches.

3. The vessel of claim 1, wherein the vessel has an overall length that is no greater than four feet.

4. The vessel of claim 1, wherein the tank is configured to contain a quantity of water gallons that is at least 2.7 times an overall length of the vessel in inches.

5. The vessel of claim 1, further comprising:
a collar coupled to a top portion of the tank; and
a lid coupled to the collar.

6. The vessel of claim 5, wherein the lid comprises a top surface that is substantially perpendicular to an imaginary longitudinal centerline of the tank, when the lid is in a closed position.

7. The vessel of claim 5, wherein:
the collar comprises a collar hinge portion, the collar hinge portion and the collar being fabricated from a single piece of sheet metal; and
the lid comprises a lid hinge portion, the lid hinge portion and the lid being fabricated from a single piece of sheet metal.

8. The vessel of claim 1, wherein the vessel complies with American Society of Mechanical Engineers standards for pressure vessels.

9. The vessel of claim 1, wherein the vessel complies with United States Department of Transportation regulations for portable cylinders.

10. The vessel of claim 1, further comprising:
a plurality of valves wherein at least three valves of the plurality of valves are substantially aligned in a straight line.

11. The vessel of claim 1, wherein the tank is configured to contain at least 320 water gallons.

12. The vessel of claim 11, wherein the tank is configured to contain at least 400 water gallons.

13. A method of loading a semitrailer with vessels, comprising:
providing a plurality of vessels, each vessel having an outside diameter that is greater than thirty inches and less than thirty-four inches, each vessel being configured to contain at least 119 water gallons, and being further configured to contain liquefied petroleum gas;
loading at least thirteen stacks of vessels on a semitrailer, wherein each stack comprises nine vessels, and wherein an imaginary centerline of each vessel is substantially horizontal.

14. The method of claim 13, further comprising:
unloading the at least thirteen stacks of vessels from the semitrailer.

15. The method of claim 13, wherein each vessel is separated from an adjacent vessel by protective material.

16. A method of loading a semitrailer with vessels, comprising:
providing a plurality of vessels, each vessel having an outside diameter that is greater than thirty inches and less than thirty-four inches, each vessel being configured to contain at least 320 water gallons, and being further configured to contain liquefied petroleum gas;
loading at least six stacks of vessels on a semitrailer, wherein each stack comprises nine vessels, and wherein an imaginary centerline of each vessel is substantially horizontal.

17. The method of claim 16, further comprising:
unloading the at least six stacks of vessels from the semitrailer.

18. The method of claim 16, wherein each vessel is separated from an adjacent vessel by protective material.
